(19) United States
(12) Patent Application Publication
(10) Pub. No.: US 2005/0231328 A1
(43) Pub. Date: Oct. 20, 2005

(54) Memory tag and a reader and methods of operation thereof

(75) Inventors: Robert John Castle, Bristol (GB); Fraser John Dickin, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/094,759

(22) Filed: Mar. 31, 2005

(30) Foreign Application Priority Data
Apr. 17, 2004 (GB) 0408597.3

(51) Int. Cl. H04Q 5/22

(52) U.S. Cl. 340/10.3; 340/10.1; 340/10.5; 340/5.71

(57) ABSTRACT

A memory tag has a memory with stored therein data, an operating program and a current password. The memory tag is operable, in response to a reader signal received from a reader, to run the operating program. This operating program is operable to check the reader signal for inclusion of a current token dependent upon the current password. If the current token is not identified within the reader signal, the memory tag does nothing. If the current token is identified within the reader signal, the memory tag is operable to read the data in the memory and transmit it to the reader.

### FIELD OF THE INVENTION

This invention relates to a memory tag powered by a signal generated by a reader, and a reader, and methods of operation of the memory tag and reader.

### BACKGROUND OF THE INVENTION

Memory tags in the form of Radio Frequency Identification (RFID) tags are well known in the prior art and the technology is well established (see for example: RFID Handbook, Klaus Finkenzeller, 1999, John Wiley & Sons). RFID tags come in many forms but all comprise an integrated circuit with information stored on it and a coil which enables it to be interrogated by a read/write device generally referred to as a reader. Until recently RFID tags have been quite large, due to the frequency they operate at (13.56 MHz) and the size of coil they thus require, and have had very small storage capacities. Such RFID tags have tended to be used in quite simple applications, such as for file tracking within offices or in place of or in addition to bar codes for product identification and supply chain management.

Much smaller RFID tags have also been developed, operating at various frequencies. For example Hitachi-Maxell have developed “coil-on-chip” technology in which the coil required for the inductive link is on the chip rather than attached to it. This results in a memory tag in the form of a chip of 2.5 mm square, which operates at 13.56 MHz. In addition Hitachi has developed a memory tag referred to as a “mu-chip” which is a chip of 0.4 mm square and operates at 2.45 GHz. These smaller memory tags can be used in a variety of different applications. Some are even available for the tagging of pets by implantation.

Although it is known to provide tags with their own power source, in many applications the tag is also powered by the radio frequency signal generated by the reader. Such a known system is shown in FIG. 1 where a reader is indicated generally at 10 and a tag at 12. The reader 10 comprises a radio frequency generator 13 and a resonant circuit part 11, in the present example comprising an inductor 14 and a capacitor 15 connected in parallel. The inductor 14 comprises an antenna. The resonant circuit part will have a particular resonant frequency in accordance with the capacitance and inductance of the capacitor 15 and the inductor 14, and the frequency generator 13 is operated to generate a signal at that resonant frequency.

The tag 12 similarly comprises a resonant circuit part generally illustrated at 16, a rectifying circuit part generally indicated at 17 and a memory 18. The resonant circuit part 16 comprises an inductor 19 which again comprises in this example a loop antenna, and a capacitor 20. The resonant circuit part 16 will thus have a resonant frequency set by the inductor 19 and capacitor 20. The resonant frequency of the resonant circuit part 16 is selected to be the same as that of the reader 10. The rectifying part comprises a forward-biased diode 21 and a capacitor 22 and thus effectively acts as a half-wave rectifier.

When the reader 10 and the tag 12 are sufficiently close, a signal generated by the frequency generator 13 will cause the resonant circuit part 11 to generate a reader signal comprising a high frequency electromagnetic field. When the resonant circuit part 16 is located within this field, a current will be caused to flow in the resonant circuit part 16, drawing power from the time varying magnetic field generated by the reader. The rectifying circuit part 17 will then serve to smooth the voltage across the resonant frequency part and provide a power supply storage. The rectifying circuit part 17 is sufficient to supply a sufficiently stable voltage to the memory 18 for the memory to operate.

To transmit data from the tag to the reader, the resonant circuit part is also provided with a switch 23, here comprising a field effect transistor (FET). The FET is connected to the memory by a control line 24. When the switch 23 is closed, it causes an increased current to flow in the tag resonant circuit part 16. This increase in current flow in the tag results in an increased current flow in the reader's resonant circuit part 11 which can be detected as a change in voltage drop across the reader inductor 14. Thus, by controlling the switch 23, data stored in the memory 18 of the tag 12 can be transmitted to the reader 10.

There are two normal communication schemes for such known memory tags. In the first, for tags without any processing capability, when power is supplied to the tag by a reader, the tag transmits its stored data to that reader. In the second, for tags which include some processing capability, the memory tag can be silent when powered and only transmit its data when asked. However, in the prior art the reader issues a generic “hello” message and each tag within range responds with its identification and some other information about itself, generally about its characteristics, such as whether it is read only and how much memory it has. If two or more tags are within range of the reader the responses will be garbled if they are all transmitted instantly and the reader will not pursue the communication. However some prior art tags are set-up to wait a random but short period of time before responding and thus the messages might not be garbled. The reader might therefore make repeated attempts to communicate before abandoning the attempt, as in the latter case with random delays the responses from different tags will eventually not overlap, and also as there are other reasons that the communication might be incomplete such as the separation between tag and reader.

However, both of the above schemes mean that any reader which can make contact with the memory tag can obtain the information stored within it. Such indiscriminate transmission of data may be inappropriate for a number of reasons. It may be that there are a number of tags within range of the reader and problems will occur if more than one transmits data at the same time. More importantly, it may be that the user of the reader is not a person for whom the data is intended. This latter reason is of greater relevance as the size of memory tags reduces such that they can be readily secreted such that they can only be located when triggered to transmit the data which they contain.

An aim of the present invention is to provide a new or improved tag and reader which reduce or overcome one or more of the above problems.

### SUMMARY OF THE INVENTION

According to a first aspect of this invention there is provided a memory tag having a resonant circuit part and a memory including a data store, an operating program and a password register in which is stored a current password;
the resonant circuit part being operable, in response to a reader signal received from a reader, to provide power 10 the memory;
the operating program being run, when power is supplied to the memory, and being operable to check the reader signal for inclusion of a current token dependent upon the current password, and,
a) if the current token is not identified within the reader signal, the memory tag doing nothing, or
b) if the current token is identified within the reader signal, the memory tag being operable to read the data in the memory and transmit it to the reader.

### BRIEF DESCRIPTION OF THE DRAWINGS

An embodiment of the present invention will now be described by way of example only with reference to the accompanying drawings, wherein:

FIG. 1 is a schematic circuit diagram of a tag and reader of known type;

FIG. 2 is a schematic circuit diagram for a memory tag and a reader embodying the present invention;

FIG. 3 is an illustration of a structure of a reader signal transmitted by the reader to the memory tag as in FIG. 2, and as used in the first and second methods of operation of the memory tag;

FIG. 4 illustrates a first method of operation of the memory tag of FIG. 2;

FIG. 5 illustrates a second method of operation of the memory tag of FIG. 2;

FIG. 6 is an illustration of a structure of a second reader signal transmitted by the reader to the memory tag, and

FIG. 7 is a schematic view of an RFID memory tag embodied in the present invention.

### DETAILED DESCRIPTION OF THE PREFERRED EMBODIMENTS

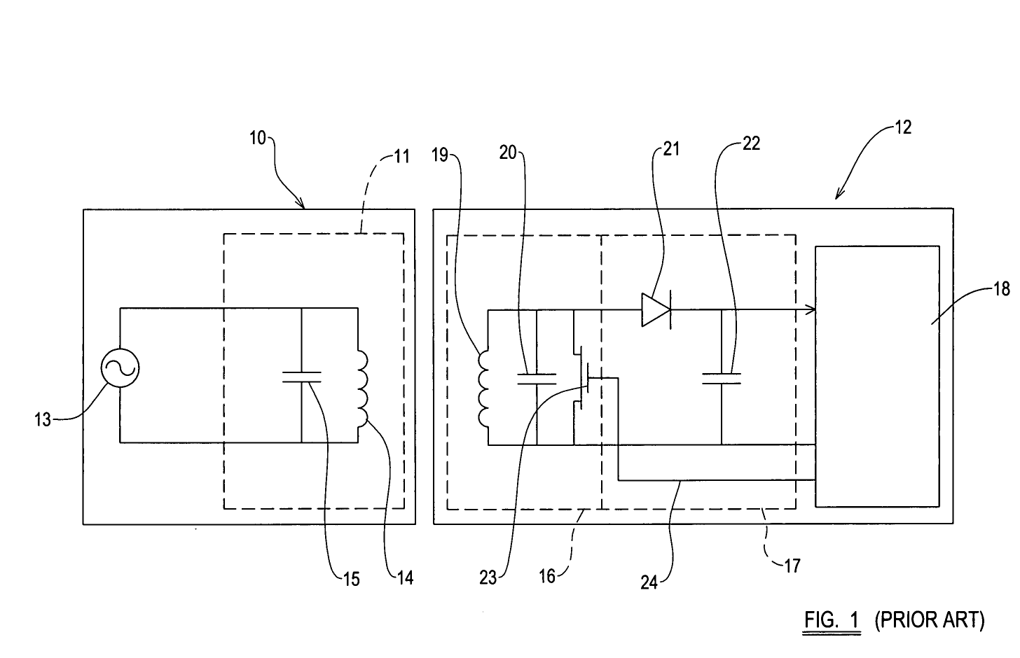

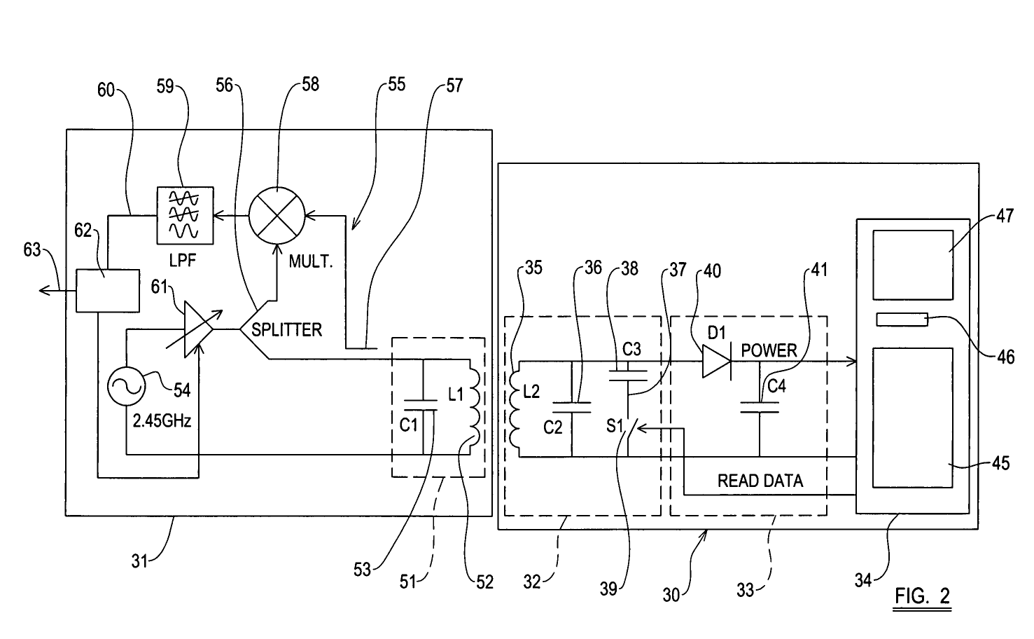

Referring now to FIG. 2, a memory tag embodying the present invention is shown at 30 and a reader shown at 31. The tag 30 comprises a resonant circuit part 32 and a rectifying circuit part 33, together with a non-volatile memory 34. The resonant circuit part 32 comprises an inductor L2 shown at 35 and a capacitor C2 shown at 36 connected in parallel in like manner to the tag 12 of FIG. 1. The resonant circuit part 32 further comprises a controllable capacitive element generally indicated at 37, in the example of FIG. 2 comprising a capacitor C3 shown at 38 and a switch S1 shown at 39. The rectifying circuit part 33 comprises a diode D1 shown at 40 connected to the resonant circuit part 32 in a forward biased direction and a capacitor C4 shown at 41 connected in parallel with the components of the resonant circuit part 32. The rectifying circuit part 33 operates in like manner to the rectifying circuit part 17 of FIG. 1 as a half-wave rectifier to provide power to the memory 34.

The memory 34 comprises a data store generally illustrated at 45, a password register 46 and an operating program 47 which is run when the tag 30 receives sufficient power via a reader signal from the reader 31.

The reader 31 comprises a resonant circuit part 51 which comprises an inductor L1 shown at 52, in this example an antenna and a capacitor C1 shown at 53 connected in parallel. A signal generator 54 is connected to the resonant circuit part 51 to provide a drive signal.

The reader 31 further comprises a demodulator, generally shown at 55. The demodulator 55 comprises a splitter 56 connected to the frequency generator to split off a part of the drive signal to provide a reference signal. A coupler 57 is provided to split off part of a reflected signal reflected back from the resonant circuit part 51, and pass the reflected signal to a multiplier shown at 58. The multiplier 58 multiplies the reflected signal received from the coupler 57 and the reference signal received from the splitter 56 and passes the output to a low pass filter 59. The low pass filter 59 passes a signal corresponding to the phase difference between the reference signal and the reflected signal to an output 60. An amplitude modulator is shown at 61 operable to control the amplitude of the drive signal supplied from the frequency generator 54 to the resonant circuit part 51, and thus send specific instructions to the tag 30.

A control unit 62 is operable to receive the output 60 from the low pass filter 59 and validate the received data. The control unit 62 is also operable to control the amplitude modulator 61.

In the embodiment shown in FIG. 2, when a signal comprising data from the data store 45 is transmitted to the reader 31 this is undertaken by operating switch S1 shown at 39. This varies the resonant frequency of the resonant circuit part 32. This change in resonant frequency causes the phase of the signal reflected from the resonant circuit part 51 to vary with respect to the signal provided by the signal generator 54. This relative phase shift can be processed by the multiplier 58 and low pass filter 59 to produce a digital output 63 as described in our earlier co-pending applications, UK Application no. 0227203.7 published under no. GB2395628 and U.S. application Ser. No. 10/697,430 published under no. US 04-0100382.

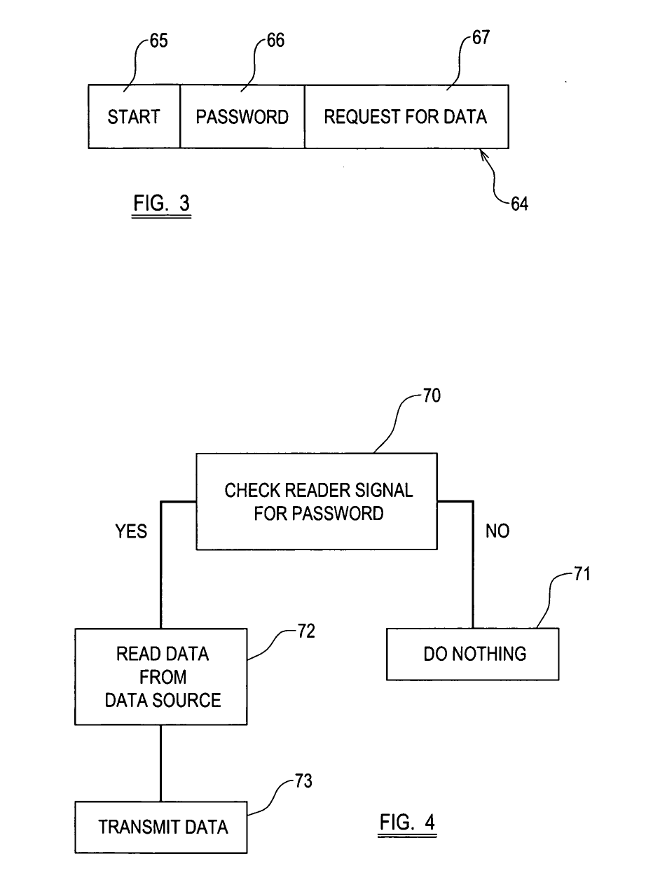

The memory tag 30 operates as follows with reference to FIGS. 3 and 4. When the tag 30 and reader 31 are brought sufficiently close together inductive coupling is established between the resonant circuit parts 51, 32, and power is supplied to the memory 34 to run the program 47.

The reader 31 may operate in one of two ways. Either it simply send signals out in a random fashion and monitors for responses, or it can identify that coupling to a memory tag may have taken place, due to the power thus taken, and in response send out a signal to the memory tag it has identified might be in range. The same effect as the coupling of a memory tag might be experienced by the reader 31 if it is adjacent to a small metal object such as a paper clip or a staple.

Whichever manner the reader 31 operates in, the form of the reader signal 64 is illustrated generally in FIG. 3, and includes a start indicator 65, the current password 66 and a request for data 67.

When such a signal is received by a tag 30 the program 47, as shown at step 70 of FIG. 4, will commence by checking whether the reader signal 64 includes the current password 66 as stored in the password register 46. If the reader signal 64 does not include the current password the tag 30 will do nothing, as shown at step 71. If however the reader signal 64 does include the current password 66, the tag 30 will operate as described for the prior art, that is the data will be read from its data store 45 (step 72) and transmitted in described manner to the reader 31 (step 73).

Thus in this method, if the reader signal received by the memory tag 30 does not contain the current token the memory tag 30 does not announce its presence in any way in response to that reader signal. As a result, even if the reader 31 has detected a power drain due to inductive coupling, it cannot determine for certain that a memory tag 30 is within range or where exactly it might be, as other objects can cause the same effects at the reader. The memory tag 30 therefore remains hidden.

In the above method the same password is used for each instance of communication between the reader 31 and the tag 30. In this case the password for the memory tag may conveniently have been stored in the memory tag at the time of manufacture.

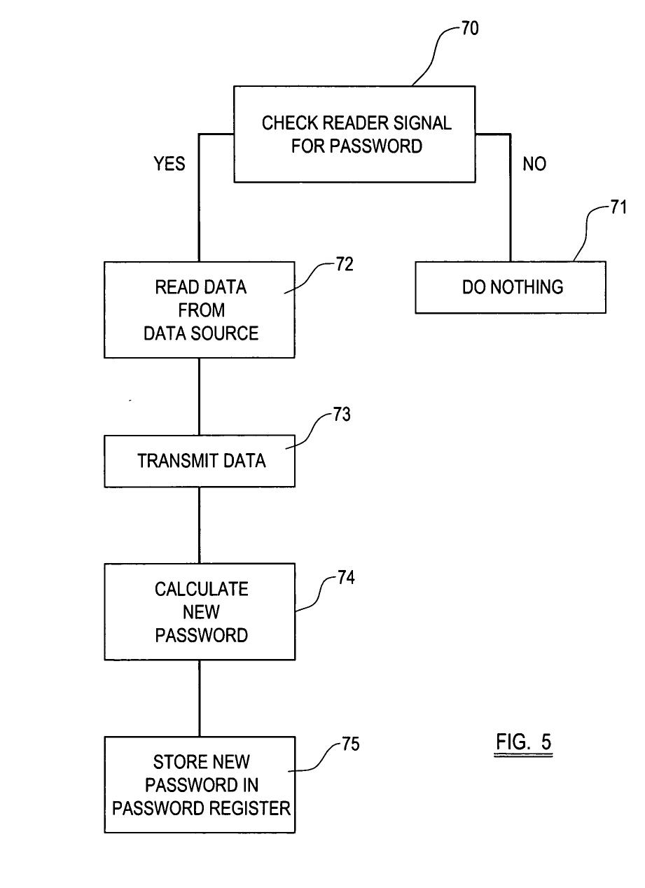

However, it may be desirable to change the password after each such communication, and such a method is illustrated in FIG. 5, where steps common to FIG. 4 are like referenced. In this embodiment the operating program 47 of the tag 30 includes a password generation routine, which may be of known kind for example including a pseudo random number generator, and which is also known to the controller 62 of the reader 31. Thus, after each transmission of data from the tag 30 to the reader 31 (step 73), the operating program 47 of the tag 30 generates the next password (step 74) and places it in the password register 46 (step 75). Likewise the controller 62 of the reader 31 also generates the next password, using the same pseudo random number generator, for inclusion in the next reader signal 64.

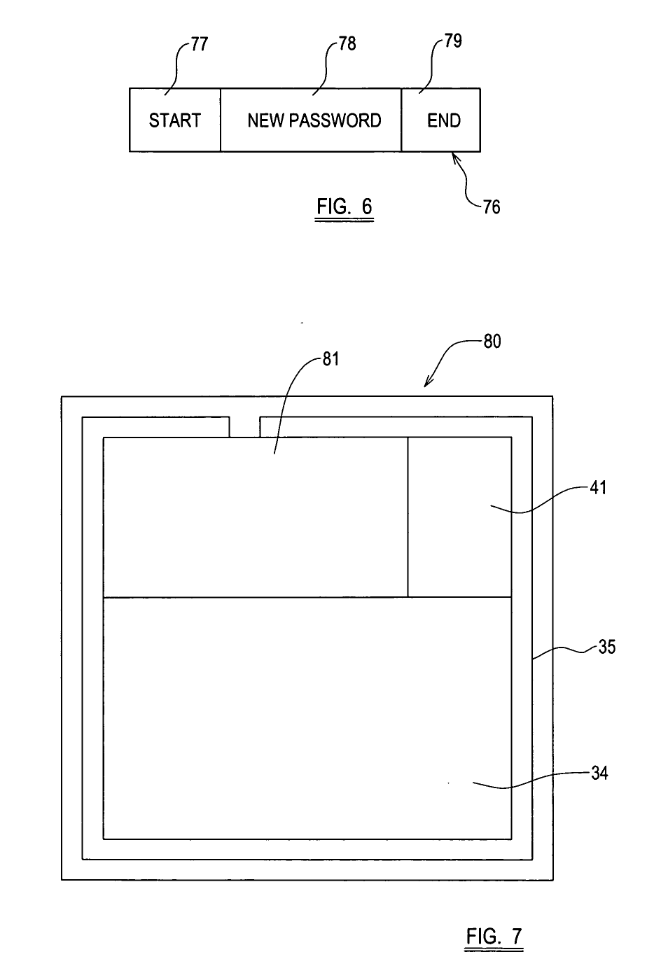

Referring now to FIG. 6, an alternative method of updating the password for subsequent communications is for the reader 31 to transmit a second signal 76 to the memory tag 30 to conclude the communication, the second signal including the new password. The second signal 76 includes a start indicator 77, the new password 78 and an end indicator 79. The new password 78 may have been user generated, either in a computer and downloaded to the reader or directly on the reader if it includes a keyboard or other input means. Alternatively the new password 78 may have been generated by a suitable password generation routine, again either in a computer and downloaded to the reader or within the reader. If communications between the reader 31 and the memory tag 30 are encrypted then clearly the new password will be also be encrypted before being transmitted to the memory tag 30 where it will be decrypted before being stored in the memory 34.

If it is desired to further improve security in the communication between the tag 30 and the reader 31 the password may be included in the reader signals 64 and 76 in encrypted form. In such embodiments the operating program 47 of the tag 30 would also include the appropriate decryption routine(s) to enable the received password to be decrypted and compared with the current password stored in the password register 46 or stored as appropriate. The decryption used may be any appropriate method.

A further alteration to the communication between the tag 30 and the reader 31, which may be used in either embodiment described above, involves the reader 31 transmitting a derivative of the password rather than the password itself. Thus, the tag 30 and reader 31, in addition to both being aware of the password also know of a function which can be applied to the password to provide the derivative. The function should, if this is to improve security, be one which when the derivative is known cannot be used to calculate the password. In this scheme therefore the reader 31 calculates the derivative and transmits it to the memory tag 30 which compares the received value with the result of the same calculation which it has also made. If the values of the derivative of the password match then the memory tag 30 will respond to the reader 31 and if not the tag 30 will remain silent.

Thus, in more general terms, what the reader 31 must send to the memory tag 30 to obtain a response to its approach is the correct token which is dependent upon the current password. This token may be a password identical to that currently stored in the memory tag 30 or a derivative of that password.

In a preferred embodiment, the resonant frequency of the resonant circuit parts 32, 51 and hence the frequency of the signal generated by the frequency source 45 is about 2.45 GHz, and the resonant frequency of the resonant circuit part 32 is modulated by about 0.05 GHz either side of this reference frequency. At this frequency, component values for the inductors and the capacitors are small, allowing easy integration of the circuit and require relatively small areas of silicon on an integrated circuit. It is particularly desirable that the tag 30 be provided as an integrated circuit, for example as a CMOS integrated circuit. A schematic of such an integrated circuit is shown at 80 in FIG. 7. The inductor L2 is shown at 35, here as an antenna coil having only a single turn although any number of turns may be provided as appropriate. The capacitor C4 is shown at 41, and the remaining components of the resonant circuit part and rectifying circuit part 33 are shown at block 81. The memory is shown at 34. The memory 34 provides 1 Mbit of capacity of non-volatile memory and is of an area of approximately 1 mm², and uses FRAM (ferroelectric random access memory) or MRAM (magnetoresistive random access memory) or similar memory technology requiring low power. The memory tag 30 is of a substantially square shape in plan view with an external dimension D for the sides of around 1 mm.

In memory tags 30 used with the first method of operation described above, with reference to FIG. 4, the password may be embedded at the time of production or stored in the password register 46 at a later date. Clearly tags 30 for use in other methods embedding of the password at the time of production would not be an option, but a password generation routine and/or decryption routine might be.

Readers 31 enabled for communication with password protected memory tags may operate according to a number of different communication schemes. It may be that the user of the reader 31 knows exactly which password protected memory tag 30 is to be communicated with and if that is the case the reader 31 can be instructed to simply send out the appropriate reader signal to communicate with that memory tag 30. However, it is equally likely that the person using the reader 31 will be unaware of the use of passwords to protect memory tags 30 and thus the reader 31 should be set-up to communicate without any specific input from the user. Thus the reader 31 might start by seeking to communicate with all memory tags within range in conventional fashion as described above in the introductory portion of this specification. If that does not provide the desired result the reader might then move on to poll all password protected memory tags 30 known to be within the relevant “system” and would thus make contact with the relevant tag 30. The time taken to undertake this whole process would only be of the order of milliseconds and therefore the user would not be aware that the communication scheme was so complex and would not experience a noticeable delay.

It will be apparent that the present invention may be used with any type of memory tag 30 and reader 31 in addition to those disclosed herein.

1. A memory tag having a memory with stored therein data, an operating program and a current password;
the memory tag being operable, in response to a reader signal received from a reader, to run the operating program which is operable to check the reader signal for inclusion of a current token dependent on the current password, and,
a) if the current token is not identified within the reader signal, the memory tag doing nothing, or
b) if the current token is identified within the reader signal, the memory tag being operable to read the data in the memory and transmit it to the reader.

2. A memory tag according to claim 1 wherein the operating program is further operable to decrypt a token included in the reader signal in encrypted form.

3. A memory tag according to claim 1 wherein the password is set at the time of manufacture of the memory tag.

4. A memory tag according to claim 1 wherein the operating program is further operable to update the password stored in the memory after each communication from the tag to the reader.

5. A memory tag according to claim 1 wherein a new password is received from the reader and stored in the memory after the data has been transmitted to the reader.

6. A memory tag according to claim 5 wherein the a new password is received from the reader in encrypted form and decrypted prior to being stored in the memory.

7. A memory tag according to claim 1 wherein the current token is the current password.

8. A memory tag according to claim 1 wherein the current token is a derivative of the current password.

9. A memory tag according to claim 8 wherein the derivative of the current password is the result of operating on the password with a function.

10. A memory tag having a resonant circuit part and a memory including a data store, an operating program and a password register in which is stored a current password;
the resonant circuit part being operable, in response to a reader signal received from a reader, to provide power to the memory;
the operating program being run, when power is supplied to the memory, and being operable to check the reader signal for inclusion of a current token dependent upon the current password, and,
a) if the current token is not identified within the reader signal, the memory tag doing nothing further, or
b) if the current token is identified within the reader signal, the memory tag being operable to read the data store in the memory and transmit data stored therein in response to the signal from the reader.

11. A reader for reading data from a memory tag, the reader being operable to transmit a reader signal to a memory tag to supply power to the memory tag and to provide a token dependent upon a password to the memory tag and request data from the memory tag, the reader also being operable to either not receive a signal comprising data from the memory tag if the token is not recognised by the memory tag, or to receive a signal comprising data from the memory tag if the token is recognised by the memory tag.

12. A reader according to claim 11 wherein the reader is also operable to generate a new password after each receipt of data from the memory tag.

13. A reader according to claim 12 wherein the new password is transmitted to the memory tag after the receipt of the signal comprising data from the memory tag.

14. A reader according to claim 11 wherein the reader is also operable to include the token in the reader signal(s) in encrypted form.

15. An information retrieval system comprising a memory tag and a reader, the memory tag having a memory with stored therein data, an operating program and a current password;
the memory tag being operable, in response to a reader signal received from a reader, to run the operating program which is operable to check the reader signal for inclusion of a current token dependent on the current password, and,
a) if the current token is not identified within the reader signal, the memory tag doing nothing, or
b) if the current token is identified within the reader signal, the memory tag being operable to read the data in the memory and transmit it to the reader, and the reader being operable to transmit a reader signal to a memory tag to supply power to the memory tag and to provide a token dependent upon a password to the memory tag and request data from the memory tag, the reader also being operable to either not receive a signal comprising data from the memory tag if the token is not recognised by the memory tag, or to receive a signal comprising data from the memory tag if the token is recognised by the memory tag.

16. A method of operating a memory tag to transmit stored data, the method including the steps of:
receiving a reader signal requesting transmission of stored data from a reader;
checking the reader signal for inclusion of a current token dependent upon a current password, as stored in a memory, and,
a) if the current token is not identified within the reader signal, the memory tag doing nothing further, or
b) if the current token is identified within the reader signal, reading the stored data from its memory and transmitting the data in response to the signal from the reader.

17. A method according to claim 16 including the additional step of decrypting the token included in the reader signal in encrypted form.

18. A method according to claim 16 including the additional step of updating the password stored in the memory after each transmission of data.

19. A method of operating a reader for reading a memory tag including the steps of:
transmitting a reader signal to a memory tag to supply power to the memory tag, and to provide a current token dependent upon a current password and to request transmission of data; and either
a) not receiving a signal in reply if the memory tag did not recognise the current token in the reader signal, or
b) receiving a signal comprising the requested data from the memory tag if the memory tag did recognise the current token in the reader signal.

20. A method of operating a reader for reading a memory tag according to claim 19 wherein it further includes the step of encrypting the current token before transmitting the reader signal.

21. A method of operating a reader for reading a memory tag according to claim 19 wherein it further includes the step of updating the current password after receiving the data from the memory tag.

22. A method of operating information retrieval system comprising a memory tag and a reader, the method including the steps of:
the reader transmitting a reader signal to the memory tag to supply power to the memory tag, and to provide a current token dependent upon a current password and to request transmission of data;
the memory tag receiving the reader signal and checking the reader signal for inclusion of the current token dependent upon the current password, as stored in a memory within the memory tag, and,
a) if the current token is not identified within the reader signal, the memory tag doing nothing further, or
b) if the current token is identified within the reader signal, the memory tag reading the stored data from its memory and transmitting the data to the reader in response to the signal from the reader.
